(19) United States
(12) Patent Application Publication
(10) Pub. No.: US 2018/0012259 A1
(43) Pub. Date: Jan. 11, 2018

(54) PRODUCT DISPLAY SYSTEMS INTEGRATED WITH BEACON TECHNOLOGY TO ASSIST SHOPPER NAVIGATION

(71) Applicant: WestRock Shared Services, LLC, Norcross, GA (US)

(72) Inventor: Phillip LAZO, Mt. Airy, MD (US)

(73) Assignee: WestRock Shared Services, LLC, Norcross, GA (US)

(21) Appl. No.: 15/542,791

(22) PCT Filed: Feb. 2, 2016
(86) PCT No.: PCT/US16/16053

§ 371 Date: Jul. 11, 2017

Related U.S. Application Data
(60) Provisional application No. 62/111,749, filed on Feb. 4, 2015.

(51) Int. Cl. G06Q 30/02

(52) U.S. Cl. CPC G06Q 30/0267; G06Q 30/0268

(57) ABSTRACT

A system is disclosed including beacons and sensors that are incorporated in point-of-purchase displays and other in-store displays. The beacons and sensors detect signals from mobile devices to activate sensory stimuli incorporated into the displays.

### REFERENCE TO RELATED APPLICATION

This application claims the benefit of priority under 35 U.S.C. §119(e) of U.S. provisional application Ser. No. 62/111,749 filed on Feb. 4, 2015 which is hereby incorporated by reference in its entirety.

### TECHNICAL FIELD

The present disclosure relates generally to product displays and more particularly (although not necessarily exclusively) to a system including beacons and sensors that are incorporated in point-of-purchase displays and other in-store displays. The beacons and sensors detect signals from mobile devices to activate sensory stimuli incorporated into the display.

### BACKGROUND

Beacon technology can be used in retail stores to engage shoppers at a point of purchase. For example, relatively low-cost Bluetooth beacons can communicate with Bluetooth-enabled smart phones. Bluetooth beacons operate by sending out a beacon signal, through the Bluetooth wireless protocol, throughout an area. Current solutions involving beacon technology typically involve providing navigation information to mobile devices for the purpose of finding products in the store. Such solutions provide a map of the store to a mobile application to assist the shopper in navigation. However, within a group of displays, it can be difficult for the shopper to find the exact display that holds the item of interest.

Improved systems and methods are desirable for using beacons in point-of-purchase displays to assist with navigation while shopping in a store.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Certain aspects and features of the present invention are directed to a retail display system that integrates beacon technology, such as a beacon using Bluetooth or another suitable short-range communication protocol, with sensory output on retail displays in a store. Short-range beacon technology can be combined with sensors that detect the presence of mobile devices in a retail shelf or other point-of-purchase display to provide contextual information to a mobile application executed on a mobile device used by a shopper in a retail store. The retail display system can be used to alert a shopper to the presence of an item of interest when the beacon detects that the mobile device is in the vicinity of the display system.

These illustrative aspects and features are mentioned not to limit or define the disclosure, but to provide examples to aid understanding of the concepts disclosed in this application. Other aspects, advantages, and features of the present disclosure will become apparent after review of the entire application.

### BRIEF DESCRIPTION OF THE DRAWINGS

FIG. 1 is a diagram showing an example of shopper's path through a store.

FIG. 2 is a diagram showing a shopper interacting with a retail display system using a mobile device.

FIG. 3 is a diagram depicting an example of a retail display system that is configured to provide sensory stimuli in combination with beacons to assist with in-store navigation.

FIG. 4 is a diagram depicting an example of a computing system that can control an interactive product display system.

### DETAILED DESCRIPTION

Improved systems and methods are disclosed that use beacons in combination with such sensory stimuli provided by retail displays to assist with in-store navigation.

The subject matter of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

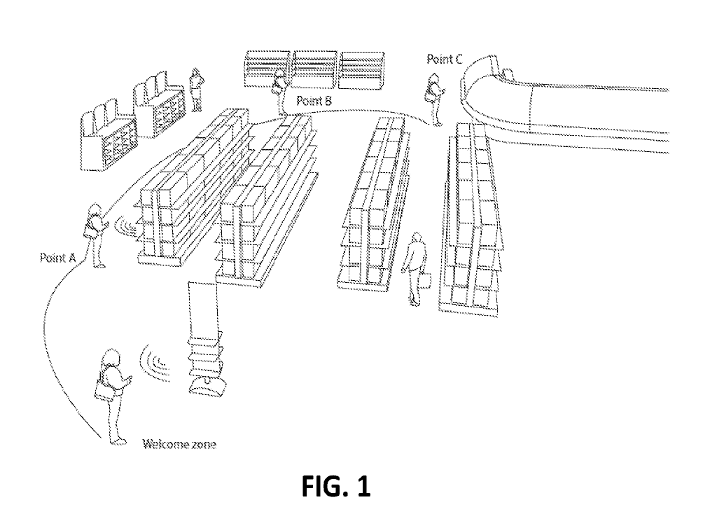

Referring now to the drawings, FIG. 1 is a diagram showing a path through a store taken by a user (e.g., a shopper, an employee, a delivery person, etc.). The user approaches a welcome zone. In some aspects, the welcome zone incorporates one or more beacons that interact with the user's mobile device. In some aspects, a shopping list may be generated by user inputs received by a mobile application executed on the mobile device, the shopping list may be received from one or more beacons in the welcome zone, or some combination of these or other operations for obtaining a shopping list can be performed. One or more devices in the welcome zone can communicate with the user's mobile device to provide navigational direction that may assist the shopper in finding the products on the list.

As depicted in FIG. 1, Point A is the location of one item of interest. The item of interest can be attached to or otherwise positioned on a retail display system having one or more beacons and one or more sensory emission devices. Examples of emission devices include light emitters, sound emitters, mechanisms to cause vibrations on a shelf, etc. The mobile device being positioned within a threshold distance of Point A can cause a beacon at point A to configure one or more sensory emission devices on the retail display system to emit one or more sensory stimuli. The sensory stimuli can direct a user's attention to the retail display system. For example, a computing system included in or communicatively coupled to the retail display can determine that the mobile device in a user's possession has moved within a threshold distance or one of a set of threshold distances. The computing system can cause a sensory stimulus (e.g., a visual and/or audio signal) to be emitted by an emission device, thereby indicating to the user that the item of interest is located on the display. In this manner, movement of the mobile device through the store (e.g., to Point B, Point C, etc.) can cause each retail display system to activate as the user approaches and deactivate as the user walks away.

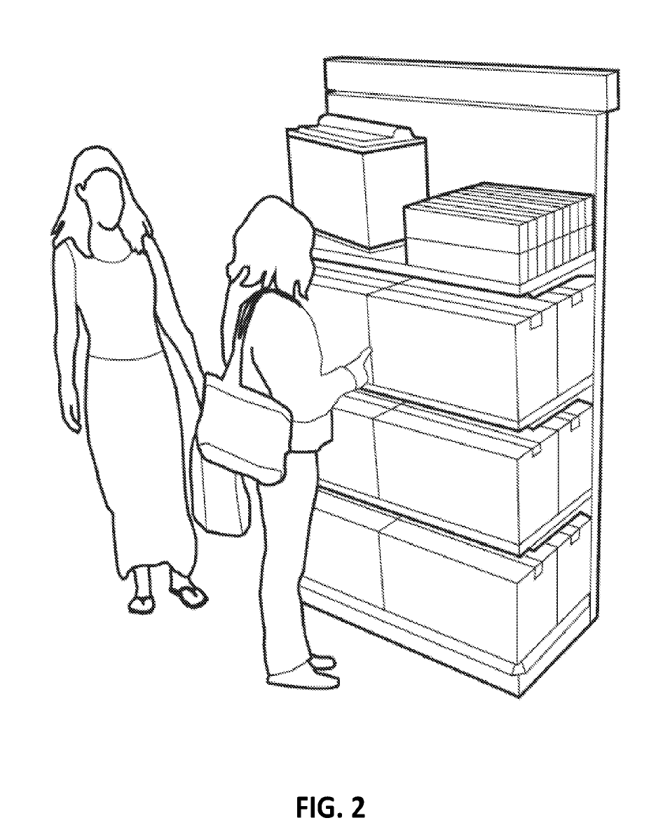

FIG. 2 is a diagram depicting an example of a retail display system that can include one or more sensory emission devices. For example, the retail display system may have a band of lights across the top, although it is possible to envision retail display systems that incorporate different placements for the lights. As the user approaches, a computing system (e.g., a microprocessor) that is included in or communicatively coupled to the retail display system can determine that a mobile device is within a threshold distance of the display system. The computing system can configure one or more sensory emission devices to cause a sensory stimuli to be emitted by one or more components of the retail display system.

In some aspects, a sensory emission device can include one or more lights. The computing system can cause the lights to activate, either as a steady glow or in a flashing pattern. The lights may be of any color. In some aspects, the lights may be a single color. In other aspects, different lights may be different colors. As a user approaches a retail display system, a computing system that is included in or communicatively coupled to the retail display system can determine that the user's mobile device has an identifier that is associated with lights of a particular color. The computing system can configure lights of the particular color to illuminate based on the mobile device being within a threshold distance of the retail display system. In another aspect, the computing system may cause the lights to flash a certain number of times for various users, such as one flash for the first user and two flashes for the second user, etc. The computing system may configure the lights to flash at a frequency that increases in response to the mobile device approaching the retail display system and to emit light in steady manner in response to the mobile device being positioned near the retail display system (e.g., within a threshold distance of one meter).

In additional or alternative aspects, a sensory emission device can include one or more devices that emit audible indicators. An audible indicator can be a sound of fixed tone and frequency, varying tone, or varying frequency, like a Geiger counter, depending on the distance of a mobile device from the retail display system. A computing system included in or communicatively coupled to the retail display system can select or otherwise control the tone, frequency, or other characteristics of the audible indicator.

In additional or alternative aspects, a retail display system can include a beacon or other transmitter. A computing system included in or communicatively coupled to the retail display system can determine that a mobile device is within a threshold distance of the retail display system. The computing system can configure the beacon or other transmitter to send a signal to the mobile device. The signal can be used by an application executed on the mobile device to cause the mobile device to vibrate, indicating to the user that the item of interest is nearby.

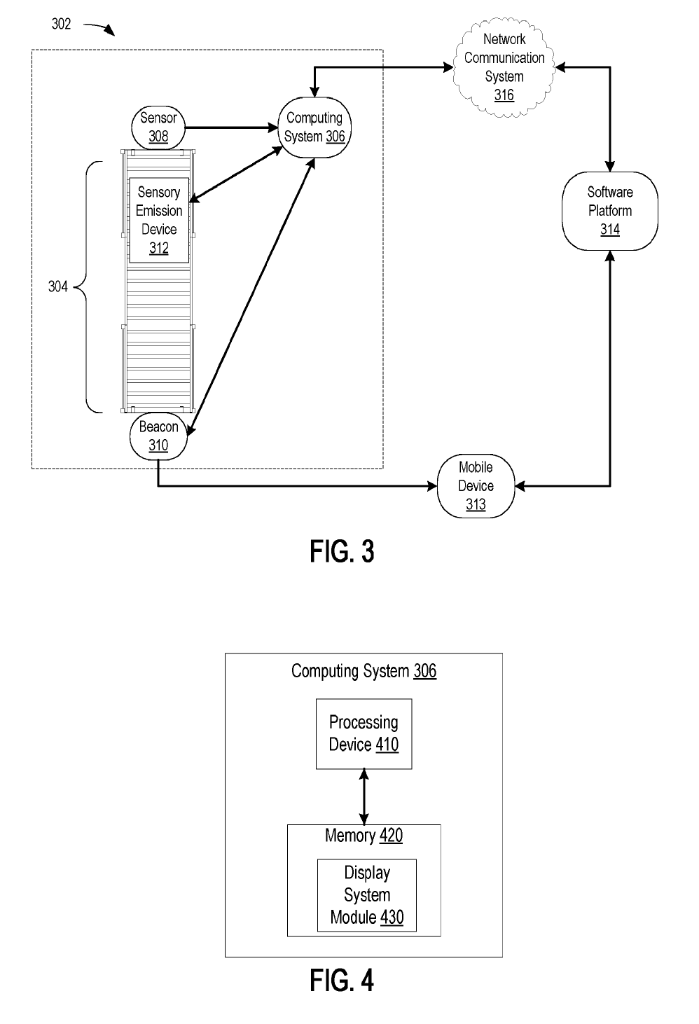

FIG. 3 is a diagram depicting an example of a retail display system 302 that is configured to provide sensory stimuli in combination with beacons to assist with in-store navigation.

The retail display system 302 can include one or more sensors 308, one or more beacons 310 that are integrated with or otherwise communicatively coupled to various retail display shelves 304, and one or more sensory emission devices 312. In other aspects, the sensor 308 and the beacon 310 can be separate devices, as depicted in FIG. 3. In other aspects, the sensor 308 and the beacon 310 can incorporated in one device. Examples of a sensor 308 include a motion sensor, a proximity sensor, and the like.

The computing system 306, one or more sensors 308, one or more beacons 310, and one or more sensory emission devices 312 can be communicatively coupled in any suitable manner. In some aspects, the computing system 306 may be placed on or incorporated into the shelves 304. The computing system 306 can communicate with one or more sensors 308, one or more beacons 310, and one or more sensory emission devices 312 via wired or wireless connections. In some aspects, one or more devices of the retail display system 302 can be positioned remotely from one another and may communicate via a data network, such as a local area network provided in a store and/or a wide area network provided by a telecommunication system in communication with one or more mobile devices 313.

In some aspects, the retail display system 302 can be operated using power from a battery or energy harvesting device. Operating the retail display system 302 using power from a battery or light harvesting device can allow the retail display system 302 to be positioned at any suitable location in the store. In other aspects, the retail display system 302 can be operated by a power outlet or other suitable power source.

A mobile device 313 (e.g., a smart phone) used by a user in the retail store may execute a mobile application that is used to communicate with the retail display system 302. The mobile application can be programmed to receive unique beacon codes or other communications from a beacon 310. If the mobile device 313 enters a coverage area of a beacon 310, the beacon 310 can cause the sensory emission device 312 to activate on the retail display system 302. The sensory emission device 312 can output lights, sounds, vibrations, etc. The indicators can direct the user to the location of a desired product or otherwise be used to assist a user with navigation through a retail store. Different zones in a retail store can include different retail display systems. Each retail display system 302 can be used to automatically detect the user's mobile device 313 in response to the mobile device 313 entering a coverage range of a beacon 310 in the retail display system 302 (e.g., as the user enters various coverage zones throughout the store). The use of multiple retail display systems 302 can allow users to find products at various locations within the store, even if individual beacons might not be strong enough to provide communication coverage for the entire store.

In some aspects, multiple retail display systems 302 can work cooperatively to direct users to different zones. For example, a first retail display system 302 having a first beacon 310 that is positioned in a first area of the store may be communicatively coupled (e.g., via a local area network) to a second retail display system 302 having a second beacon 310 that is positioned in a second area of the store. (The beacons 310 may be included in or communicatively coupled to their respective retail display systems 302.) Each of the beacons 310 may have a coverage range that is limited to a respective one of the areas, such that the first beacon 310 may be unable to reliably communicate with a mobile device if the device is positioned in the second area, and the second beacon 310 may be unable to reliably communicate with the mobile device if the device is positioned in the first area.

A desired product from the store may be identified on the mobile device and may be located in the second area. The first retail display system 302 can use the first beacon 310 to determine that the mobile device is positioned in the first area. The first retail display system 302 can also use the first beacon 310 to identify one or more desired products in the store. The first retail display system 302 can determine that one of the desired products is in a second area that is adjacent to the first area or that is otherwise visible from the first area (e.g., an area further down an aisle in the store). The first retail display system 302 in the first area can transmit one or more messages via a data network to the second retail display system 302 in the second area indicating that the mobile device is positioned in the first area and is being used to locate a product located in the second area. The second retail display system 302 can configure a sensory emission device 312 to emit one or more sensory stimuli based on receiving the message from the first retail display system 302. The emission of one or more sensory stimuli by the second retail display system 302 can influence the user of the mobile device to move into the second area, thereby allowing a second beacon 310 from the second retail display system 302 to communicate with the mobile device.

In some aspects, network communication system 316, such as a server or cloud-based platform can communicate with the computing system 306 or another device of the retail display system 302 (e.g., the beacon 310). The retail display system 302 can use the network communication system 316 for communicating product information (e.g., brand, product location, promotions, etc.) to the mobile device 313 through the software platform 314. For example, a processing device included in or communicatively coupled to the computing system 306 and/or the beacon 310 can use 3G, Bluetooth, or another suitable communication protocol to obtain an identifier of the mobile device 313. The processing device can provide the identifier to a server via a data network. The server can cause navigational directions to be transmitted (e.g., via a “push” notification) to the mobile device 313 via the mobile application executed on the mobile device.

In some aspects, a system that includes one or more retail display systems 302 may determine the identity of the user. For example, one or more retail display systems 302 communicatively coupled to a telecommunication system or other wide-area network can communicate with one or more systems via the wide-area network to track a user as the user moves through a store. For example, if 3G or another suitable long-range communication protocol is available inside the store, communication between the mobile device 313 and the retail display system 302 can be implemented using one or more of a short-range communication protocol (e.g., Bluetooth) and a long-range communication protocol (e.g., 3G). If 3G or another suitable long-range communication protocol is not available inside the store, communication between the mobile device 313 and retail display system 302 can be implemented using Bluetooth or another short-range communication protocol.

In additional or alternative aspects, a mobile application executed on the mobile device 313 can use a microphone on the mobile device to send or receive an ultrasonic signal or an audio spectrum to a receiver on the display. In such an aspect, a sensor would include a microphone that can detect an ultrasonic signal or audio spectrum emitted from the phone. Detection of the ultrasonic signal or audio spectrum can cause the sensory emission device 312 to activate. In additional or alternative aspects, the ultrasonic signal or audio spectrum can be emitted from the sensory emission device 312 and can be detected by a microphone on the mobile device. The detection of the ultrasonic signal or audio spectrum would cause the application on the mobile device to perform an operation to alert the user.

The sensory emission device 312 of the system depicted in FIG. 3 can be implemented in any suitable manner.

In some aspects, the sensory emission device 312 can include lights that flash at a fixed or variable speed. The lights might be a fixed color for all users or color-coded to particular mobile devices. In other aspects, the sensory emission device 312 can include an audible indicator, such as a beep, that can repeat at a fixed or variable speed. In still other aspects, the sensory emission device 312 can include both lights and audible indicators as described above. The sensor 308 can activate the sensory emission device 312 as the mobile device 313 approaches the retail display system 302.

FIG. 4 is a block diagram depicting an example of a computing system 306 for processing inputs received using the sensor 308 and outputting commands for activating a beacon 310 and/or controlling a sensory emission device 312 according to some aspects. The computing system 306 can include a processing device 402 that includes or is communicatively coupled with a memory device 404. Examples of processing device 402 include a microprocessor, an application-specific integrated circuit (“ASIC”), a field-programmable gate array (“FPGA”), or other suitable processor. The processing device 402 may include one processor or any number of processors. The memory device 404 can be a non-transitory computer-readable medium for storing program instructions. The processing device 402 can execute the program instructions stored in the memory device 404. The executable program instructions can include a display system module 406. The display system module 406 can perform one or more of the operations for communicating with one or more sensors 308, communicating with and configuring one or more beacons 410, and/or communicating with and configuring one or more beacons and/or one or more sensory emission devices 312 as described herein.

In certain embodiments, the retail display system 302 may be a point-of-purchase display such as a shelf-ready shipper display system, or an end cap display system. Such systems may be used to provide displays for seasonal or promotion products. With such temporary displays, it may be useful for the product manufacturer, store headquarters, or other interested parties to know the date range for which the display was actually in use, and to know the amount of interest generated by the display. A point of purchase display may therefore be provided with at least one beacon 310 integrated or otherwise attached or associated with the point of purchase display.

When the point of purchase display is in transit (e.g. during shipping, or in storage before being placed on the sales floor) the beacon 310 may either be powered off, or may not be in range of any mobile devices 313. Once the point of purchase display is placed on the sales floor and the beacon is powered on, mobile devices 313 may then detect the beacon signal and begin to communicate with software platform 314 (e.g., on the Internet) to receive information about products on the point of purchase. Also, the software platform may collect data indicating the number of times the particular beacon 313 has caused a request for information to be sent to the software platform. When the point-of-purchase display is taken off the sales floor, the beacon will cease to generate further requests for information. Thus the point of purchase display with its dedicated beacon 310 may be used (through the software platform 314) to provide data to the product manufacturer, store headquarters, or other interested parties indicating how long the point-of-purchase display was on the sales floor, and how much product interest it generated. Such data may allow interested parties to better assess how effectively promotional displays are utilized, especially during periods such as seasonal events (e.g. Thanksgiving, Christmas, Easter) or time-critical events (release of a popular movie, new product, etc.)

The foregoing description of aspects and features of the disclosure, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of this disclosure. Aspects and features from each example disclosed can be combined with any other example. The illustrative examples described above are given to introduce the reader to the general subject matter discussed here and are not intended to limit the scope of the disclosed concepts.

1. A display system for use with a mobile device, the system comprising:
a first support structure to support one or more products;
a first computing system associated with the support structure;
a first beacon emitting a signal identifying the first beacon; and
a first sensory emission device in communication with the computing system;
wherein the computing system and the mobile device communicate with a software platform on the Internet;
wherein the mobile device upon receiving the signal from the beacon communicates to the software platform, the software platform communicates to the computing system, and the computing system causes the sensory emission device to emit light or sound.

2. The display system of claim 1, wherein the first support structure comprises at least one shelf.

3. The display system of claim 2, wherein the sensory emission device is incorporated in or on the shelf

4. The display system of claim 1, wherein the beacon is a radio device transmitting a unique identifier.

5. The display system of claim 1, wherein the sensory emission device is incorporated in or on the beacon.

6. The display system of claim 1, further comprising a sensor to detect the mobile device.

7. The display system of claim 1, wherein the computing system configures the beacon to send a signal to the mobile device.

8. The display system of claim 1, further comprising a second support structure and a second sensory emission device, wherein the first computing system communicates with the second sensory emission device and causes the second sensory emission device to emit light or sound.

9. The display system of claim 1, further comprising a second support structure, a second computing system, and a second sensory emission device, wherein the first computing system communicates with the second computing system, and the second computing system causes the second sensory emission device to emit light or sound.

10. The display system of claim 1, wherein the first support structure is a retail-ready display.

11. The display system of claim 1, wherein the first support structure is a point-of-purchase display.

12. A display system for use with mobile devices, the system comprising:
a first support structure to support one or more products;
a first beacon emitting a signal identifying the first beacon;
a software platform accessible through the Internet;
wherein the mobile devices upon receiving the signal from the beacon communicate the identifying signal to the software platform; and
wherein the software platform creates a list of the times at which the mobile devices communicate the identifying signal to the software platform.

13. The display system of claim 12, wherein the software platform uses the list to determine a time interval during which the first support structure is in use.

14. A method using mobile devices to determine a time interval when a retail display is in use, the method comprising:
providing a first support structure to support one or more products;
associating with the first support structure a first beacon emitting a signal including an identifier identifying the first beacon;
providing a software platform accessible through the Internet;
determining each time a mobile device upon receiving the signal from the beacon communicates the identifier to the software platform;
whereby the software platform creates a list of the times at which the mobile devices communicate the identifying signal to the software platform;
and whereby the software platform uses the list to determine a time interval during which the retail display is in use.
